(19) United States
(12) Patent Application Publication
(10) Pub. No.: US 2025/0371115 A1
(43) Pub. Date: Dec. 4, 2025

(54) An Artificial Intelligence (AI) System for Processing of an Input and a Method Thereof

(71) Applicants: Robert Bosch GmbH, Stuttgart (DE); Bosch Global Software Technologies Private Limited, Bangalore (IN)

(72) Inventor: Manojkumar Somabhai Parmar, Ahmedabad (IN)

(21) Appl. No.: 18/878,048

(22) PCT Filed: Jun. 27, 2023
(86) PCT No.: PCT/EP2023/067512

§ 371 Date: Dec. 22, 2024

(30) Foreign Application Priority Data
Jun. 27, 2022 (IN) 202241036684

(51) Int. Cl. G06F 21/12; G06F 21/55

(52) U.S. Cl. CPC G06F 21/121; G06F 21/554; G06F 2221/031

(57) ABSTRACT

An Artificial Intelligence (AI) system for processing of an input and a method thereof is disclosed. The AI system includes an input interface, an output interface, a defense module, an AI module, and at least a cache processing unit. The defense module is adapted to receive input from the at least one user and identify an attack vector amongst the input. The cache processing unit is configured to store characteristics of the received inputs. The characteristics of the received inputs include at least an identification information of the attack vector. The cache processing unit restricts the AI module from processing the input on recognition of attack vector in the input. The AI module processes input data in dependance of communication received from the cache processing unit and the defense module.

### FIELD OF THE INVENTION

The present disclosure relates to the field of artificial intelligence. In particular, the present disclosure proposes an Artificial Intelligence (AI) system for processing of an input and a corresponding method thereof.

### BACKGROUND OF THE INVENTION

With the advent of data science, data processing and decision making systems are implemented using artificial intelligence modules. The artificial intelligence modules use different techniques like machine learning, neural networks, deep learning etc. Most of the AI based systems, receive large amounts of data and process the data to train AI models. Trained AI models generate output based on the use cases requested by the user. Typically the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs and give a desired output, the AI systems use various models/algorithms which are trained using the training data. Once the AI system is trained using the training data, the AI systems use the models to analyze the real time data and generate appropriate result. The models may be fine-tuned in real-time based on the results. The models in the AI systems form the core of the system. Lots of effort, resources (tangible and intangible), and knowledge goes into developing these models.

Currently, all AI models are deployed in pipeline line/serial fashion for embedded/IoT devices. They take input, process it using AI model and provide output. The models/pipeline always assumes that the data is new, and it needs to be processed. That means it results in repetitive calculations, even if the input is the same. This is even more complicated in case the AI model also have defense model running simultaneously for checking if the input is adversarial or an attack vector. The assumption also results in increased energy consumption without providing any benefits and sometimes slows down the overall system. The nature of IoT and embedded devices are such that signals are not generally fast-changing considering their low sampling frequency. Therefore, the input remains stable for a given time slice within which there is no need to calculate the output of AI models which are compute heavy.

### BRIEF DESCRIPTION OF THE ACCOMPANYING DRAWINGS

An embodiment of the invention is described with reference to the following accompanying drawings:

FIG. 1 depicts an AI system (100) for processing of an input;

FIG. 2 illustrates method steps (200) of processing an input in an Artificial Intelligence (AI) system (100).

### DETAILED DESCRIPTION OF THE DRAWINGS

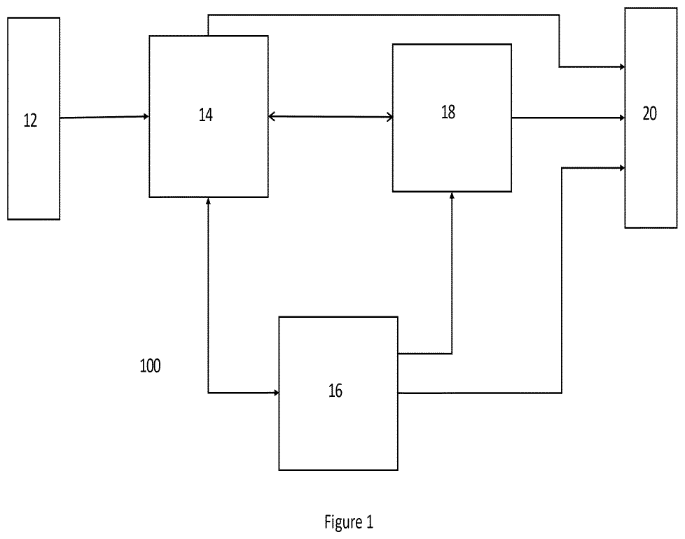

FIG. 1 depicts an Artificial Intelligence (AI) system (100) for processing of an input. The artificial intelligence system (100) comprises an input interface (12), an output interface (20), a defense module (16), an AI module (18) and at least a cache processing unit (14).

The input interface (12) receives input from at least one user. The input interface (12) is a hardware interface wherein a user can enter his query for the AI module (18) to process and generate an output. The output interface (20) is an audio or visual display hardware that sends an output or a signal to said at least one user.

A module with respect to this disclosure can either be a logic circuitry or a software programs that respond to and processes logical instructions to get a meaningful result. A module is implemented as any or a combination of: one or more microchips or integrated circuits interconnected using a parent board, hardwired logic, software stored by a memory device and executed by a microprocessor, microcontrollers, firmware, an application specific integrated circuit (ASIC), and/or a field programmable gate array (FPGA). Various modules can either be a software embedded in a single chip or a combination of software and hardware where each module and its functionality is executed by separate independent chips connected to each other to function as the system (100). For example, a neural network (an embodiment of the AI module (18)) mentioned herein after can be a software residing in the system (100) or the cloud or embodied within an electronic chip. Such neural network chips are specialized silicon chips, which incorporate AI technology and are used for machine learning.

The defense module (16) is adapted to receive input from said at least one user and identify an attack vector amongst said input. An attack vector is an adversarial input aimed at compromising the function of the AI module (18) or stealing the algorithm or the logic beneath the AI module (18). A model stealing attack uses a kind of attack vector that can make a digital twin/replica/copy of an AI module (18).

The defense module (16) uses numerous techniques to identify an attack vector amongst the inputs. These techniques use statistical and mathematical analysis along with analysis of the features in the artificial intelligence domain. In some techniques, the defense module runs a second model which is a variation of the model run by the AI module. For example, the second model has different network parameters from the model run by the AI module. The defense module in some embodiment also comprises a comparator and more than one AI model being executed. The defense model is designed and constructed for statistical, mathematical and artificial intelligence and machine domain analysis of the input to identify an attack vector. The defense module (16) The identification information of the attack vector is stored in a memory of the cache processing unit (14). The defense module (16) restricts the AI module (18) from processing the input on identification of attack vector in the input.

The cache processing unit (14) is again a hardware or software and hardware module configured to store characteristics of the received inputs. The characteristics of the received inputs include at least an identification information of the attack vector. The cache processing unit (14) restricts the AI module (18) from processing the input on recognition of attack vector in the input.

The AI module (18) processes said input data and generate the output in dependance of communication received from the cache processing unit (14) and the defense module (16). AI module (18) with reference to this disclosure can be explained as a component which runs a model. A model can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. It must be understood that this disclosure is not specific to the type of model being executed in the AI module (18) and can be applied to any AI module (18) irrespective of the AI model being executed. A person skilled in the art will also appreciate that the AI module (18) may be implemented as a set of software instructions, combination of software and hardware or any combination of the same.

It should be understood at the outset that, although exemplary embodiments are illustrated in the figures and described below, the present disclosure should in no way be limited to the exemplary implementations and techniques illustrated in the drawings and described below. As explained above, these various modules can either be a software embedded in a single chip or a combination of software and hardware where each module and its functionality is executed by separate independent chips connected to each other to function as the system (100).

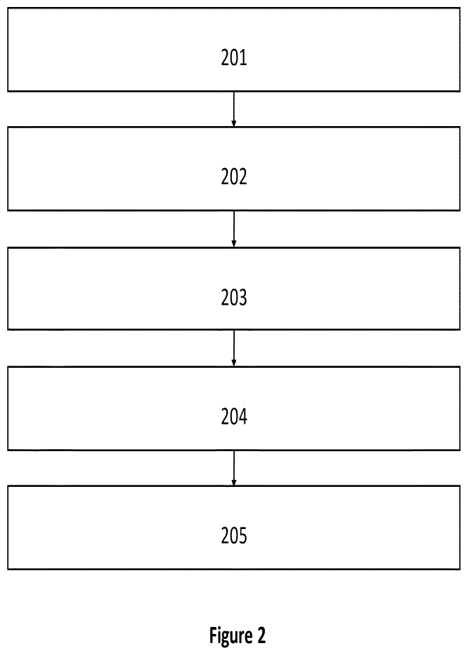

FIG. 2 illustrates method steps of processing an input in an Artificial Intelligence (AI) system (100). The AI system (100) (100) and its components have been elucidated above in accordance with FIG. 1.

Method step 201 comprises transmitting the input received to the cache processing unit (14). Method step 202 comprises recognizing the input by comparing characteristics of the input with characteristics of previous inputs stored in a memory of the cache processing unit (14).

Method step 203 comprises identifying an attack vector in the input by means of the defense module (16) in dependance of recognition. The techniques for identification of an attack vector have been discussed in brief in above paragraphs. In an alternate embodiment of the present disclosure, the attack vector identification information is further used to calculate an information gain. If the information gain exceeds a pre-defined threshold, the user is blocked, and the notification is sent the owner of the AI system (100) (100). If the information gain is below a pre-defined threshold, although an attack vector was detected, output generated by the AI module (18) may be modified and sent to the output interface (20).

In addition, the user profile may be used to determine whether the user is habitual attacker or was it one time attack or was it only incidental attack etc. Depending upon the user profile, the steps for unlocking of the system (100) may be determined. If it was first time attacker, the user may be locked out temporarily. If the attacker is habitual attacker then a stricter locking steps may be suggested.

Method step 204 comprises storing the characteristics of the attack vector in the memory of the cache processing unit (14). The characteristics of the attack vector include not only the attack vector identification but also the metadata associated with the attack such as the user profile, frequency of attack, time stamps, severity of attack and the like.

Method step 205 comprises processing the input data by means of the AI module (18) to generate the output in dependance of communication received from the cache processing unit (14) and the defense module (16). The processing of input data by means of the AI module (18) is restricted on recognition of attack vector.

The core of the invention is based on the idea that IoT and embedded devices signals are not fast-changing and they perform a repetitive calculation. Hence a caching mechanism with a memory of the characteristics of the cached data is implemented to store fixed (small number) input and output pairs. The caching will ensure that whenever consecutively the same inputs are detected, then output is provided without involving the heavy calculation of AI Models. The caching will be resulting in increased throughput, reduced computing cycles and reduced energy consumption for edge devices powered by AI algorithms.

In one embodiment of the present system (100) as depicted in FIG. 1, a parallel caching mechanism is implemented. Here identifying an attack vector comprises a parallel processing by the cache processing unit (14) and the defense module (16). Any time, a new input comes, in parallel to processing it, the search is initiated in the memory of the cache processing based on the characteristics of the input. If a search is successful, then output is provided, and processing of AI model is stopped. This ensures that the overall performance of the model is not impacted as the time taken to process any input is always less than or equal to the first-time encountering input. However, it will have an impact on computing and energy efficiency.

In an alternate embodiment of the present system (100) in accordance with FIG. 1, another caching mechanism is to be implemented. Here identifying an attack vector comprises a sequential processing of the input by the cache processing unit (14) and the defense module (16). Any time, a new input comes, first it goes to cache processing unit (14). Cache processing initiates a search in the database for matching input. If a search is successful, then output is provided, and the AI model is never invoked for processing data. If a search is unsuccessful, then the AI model and correspondingly the defense model is invoked, and output is provided. The memory is also updated with new input and output pair. This ensures that maximum compute and energy efficiency is achieved as duplicate processing is completely stopped.

In both cases, the overall performance (throughput, energy) is heavily dependent on the size of the memory of cache processing unit (14) and mechanism to update it to get optimal hit ratio in caching. The size of the memory is minimal in embedded and IoT devices. Therefore, depending on the rate of change of input, the available computing power of device, AI model compute needs, memory size of the cache processing unit (14) is decided, and the trade-off is made between the performance of system (100) and capacity of cache processing unit (14). The characteristics of an attack characteristics are stored for in the cache processing unit (14) for a particular duration depending upon a frequency of the input. The more the same input appears, it stays longer in the memory of the cache processing unit (14). Alternate mechanisms can be used to update the memory to improve performance as they are dependent on the use-case and input data stream.

A person skilled in the art will appreciate that while these method steps describe only a series of steps to accomplish the objectives, these methodologies may be implemented with modification and adaptations to the system (100) disclosed herein.

This idea to develop an Artificial Intelligence (AI) system (100) for processing of an input and a method thereof is applicable when AI models do not involve any history/memory element or active learning mechanism (learning on the fly from incoming data). The AI model caching technique is inspired from the conventional processor architecture with caching mechanism. Within processor architecture, cache prefetching is a technique used by computer processors to boost execution performance by fetching instructions or data from their original storage in slower memory to a faster local memory before it is actually needed. This is used to improve the performance of a processor by partially eliminating the wait time of processor due to memory latency.

It must be understood that the embodiments explained in the above detailed description are only illustrative and do not limit the scope of this invention. Any modification and adaption of the Artificial Intelligence (AI) system (100) for processing of an input and the method thereof are envisaged and form a part of this invention. The scope of this invention is limited only by the claims.

1. An Artificial Intelligence (AI) system for processing of an input, comprising:
an input interface configured to receive input from at least one user;
an output interface configured to send an output to said at least one user;
a defense module configured to receive input from said at least one user, the defense module further being configured to identify an attack vector amongst said input, said identification information of the attack vector being stored in a memory of a cache processing unit, the cache processing unit being configured to store characteristics of the received inputs; and
an AI module configured to process said input data and generate the output in dependance of communication received from the cache processing unit and the defense module.

2. The Artificial Intelligence (AI) system as claimed in claim 1, wherein characteristics of the received inputs include at least an identification information of the attack vector.

3. The Artificial Intelligence (AI) system as claimed in claim 1, wherein the cache processing unit is configured to restrict the AI module from processing the input on recognition of the attack vector in the input.

4. The Artificial Intelligence (AI) system as claimed in claim 1, wherein the defense module is configured to restrict the AI module from processing the input on identification of the attack vector in the input.

5. A method of processing an input in an Artificial Intelligence (AI) system, the system comprising: an input interface configured to receive input from at least one user; an output interface configured to send an output to said at least one user; a defense module configured to receive input from said at least one user; a cache processing unit in communication with the output interface; and an AI module, the method comprising:
transmitting the input received to the cache processing unit;
recognizing the input by comparing characteristics of the input with characteristics of previous inputs stored in a memory of the cache processing unit;
identifying an attack vector in the input by way of the defense module in dependance of recognition information received from the cache processing unit;
storing the characteristics of the attack vector in the memory of the cache processing unit; and
processing the input data by way of the AI module to generate the output in dependance of communication received from the cache processing unit and the defense module.

6. The method as claimed in claim 5, wherein processing the input data by way of the AI module is restricted on recognition of the attack vector.

7. The method as claimed in claim 5, wherein identifying an attack vector comprises a parallel processing by the cache processing unit and the defense module.

8. The method as claimed in claim 5, wherein identifying an attack vector comprises a sequential processing of the input by the cache processing unit and the defense module.

9. The method as claimed in claim 5, wherein the characteristics of an attack characteristics are stored in the cache processing unit for a particular duration depending upon a frequency of the input.
